(19) United States
(12) Patent Application Publication
(10) Pub. No.: US 2011/0127319 A1
(43) Pub. Date: Jun. 2, 2011

(54) RESEALABLE FLEXIBLE FILM PACKAGING PRODUCTS AND METHODS OF MANUFACTURE

(75) Inventor: Martin H. GOLDEN, Highland Park, NJ (US)

(73) Assignee: KRAFT FOODS GLOBAL BRANDS LLC, Northfield, IL (US)

(21) Appl. No.: 12/628,533

(22) Filed: Dec. 1, 2009

(51) Int. Cl. B65D 77/30; B31B 1/90; B65D 17/50; B65D 5/42

(52) U.S. Cl. 229/123.1; 229/245; 229/247; 229/126; 493/102

(57) ABSTRACT

Products and methods for flexible flow-wrap film packaging that allow easy opening and resealing, while maintaining package integrity. The film can have a flexible sheet material having a sealant layer on a first surface; the flexible sheet longitudinally sealed generally along adjacent sides to form a sleeve, the first surface forming an interior of the sleeve and adjacent surfaces of the longitudinal seal; a first sleeve end having a peelable seal; a second sleeve end having a second seal; and the first sleeve end further having a pair of opposing peel tabs in an unsealed area distal to the peelable seal. The film can be polypropylene, polyethylene, and the like. The sealant layer can be ethylene vinyl acetate (EVA), ionomer plastic, matallicine, orgaonclay, and the like. Reclosure means can include the addition of nylon to the film, wire ties, peelable seals, or an internal band of a pressure sensitive adhesive.

### FIELD

The present products and methods relate to flexible film packaging, and in particular to products and methods for flexible flow-wrap film packaging that allow easy opening and resealing, while maintaining package integrity.

### BACKGROUND

Flexible film packages are known in the art to provide a bag or pouch to retain products for shipping and storage. These types of containers can have ‘flow wrap’ type packaging, which allows a continuous film to envelop the product during packaging. Specifically, flow wrapping (also known as horizontal or vertical fin-seal wrapping, endseal wrapping, horizontal bagging and pillow-pouch packaging) is a process in which a product is wrapped in a film, such as from a roll of clear or printed structure (such as a polyethylene or polypropylene film) and sealed along a fin/bottom and at its ends. The result is a flexible package with a non-lap type seal on the bottom and end seals. Since these types of packaging methods can provide hermetically sealed enclosures, they can provide suitable package interior protection against contamination by moisture, oxygen, and ambient atmosphere. Flexible packaging is often used for food products such as sleeves of crackers, cookies and the like.

Flexible film packages have many advantages. Flexible packaging can be manufactured at substantially lower cost than rigid containers. Flexible containers are also substantially lighter in weight, thereby resulting in reduced transportation costs and can pack easier resulting in less storage space.

Despite these advantages, flexible packaging is typically not suitable when a user wants to reclose the container after its initial opening, such as when there is more product within the package than for a single use. The seams of these types of flexible containers are usually permanent to provide an airtight seal and structural integrity. Such seals can be formed by heat sealing or welding techniques. Thus, the container must be opened by cutting or tearing the film or one or more of its seams, or by a user holding the package and attempting to pull the seal apart. For example, a flow wrap for a sleeve of crackers is often opened by tearing open the package film or peeling its sealed edge. Although not all of the product is immediately consumed, the package is frequently unable to reclose even though product may still remain.

Attempts are known in the art to assist in the ease of opening this type of packaging using peel tabs (see generally, U.S. Pat. No. 5,352,466 to Delonis), but does not allow for resealing of flow wrap applications.

### SUMMARY

Accordingly, provided herein is a flexible flow-wrap package, which has a seal against ambient atmosphere (e.g., to retain freshness) for extended periods of time, and yet “consumer friendly” in that it has a readily-grippable unsealed area above an end seal so that it can be easily opened and resealed, while maintaining package integrity.

One embodiment provides a resealable flexible film package having a flexible sheet material having a sealant layer on a first surface; the flexible sheet longitudinally sealed generally along adjacent sides to form a sleeve, the first surface forming an interior of the sleeve and adjacent surfaces of the longitudinal seal; a first sleeve end having a peelable seal; a second sleeve end having a second seal; and the first sleeve end further having a pair of exterior opposing peel tabs in an unsealed area adjacent to the peelable seal. The flexible sheet material can be selected from a list of polypropylene, polyethylene, and the like. The sealant layer is selected from the list of ethylene vinyl acetate (EVA), ionomer plastic, matallicine, orgaonclay, and the like.

The flexible sheet can optionally also be a twist retaining film. In this embodiment, nylon may be added as a laminate layer.

The present embodiments can also have reclosure means such as by the addition of a wire tie, peelable seal affixed to the sleeve proximate to the peelable seal, whereby reclosure of an opened package can be achieved. Also, a band of pressure sensitive adhesive on the first surface of the sleeve proximate to the peelable seal can be added.

The peelable seal can be formed by a sealant layer of EVA and the like heated to a range of between about 85 and 190 degrees Celsius.

Methods to manufacture a resealable flexible film package of the present embodiments can include the steps of feeding film from a film roll to envelop a product; forming a fin seal by joining opposite edges of the film; forming a first end seal; cutting a pair of peel tabs in an unsealed area; and forming a peelable end seal.

The method can include the step of feeding the film and forming the fin seal using heated wheels and the film has a heat activated sealant layer. The wheels can be heated to between about 85 and 205 degrees Celsius.

The method of forming a first end seal can include cutting a pair of peel tabs in an unsealed area, and forming a peelable endseal using a pair of rotating seal jaws. The seals can optionally add crimping.

Where the film has a heat activated film layer, the step of forming the peelable end seal can include the step of heating the rotating seal jaws to between about 85 and 190 degrees Celsius.

Other features will become more apparent to persons having ordinary skill in the art to which the container pertains and from the following description and claims.

### BRIEF DESCRIPTION OF THE DRAWINGS

The foregoing features, as well as other features, will become apparent with reference to the description and figures below, in which like numerals represent like elements, and in which:

FIG. 1 is a perspective view of an exemplary re-sealable flexible film packaging product;

FIG. 2 is a perspective view of an exemplary re-sealable flexible film packaging product having an optional longitudinal wire tie;

FIG. 3 is a perspective view of an exemplary re-sealable flexible film packaging product having an optional pressure sensitive label;

FIG. 4 is a perspective view of an exemplary re-sealable flexible film packaging product having an optional interior pressure sensitive press closure layer;

FIG. 5 is a planar view of a film package strip section of a package of FIG. 1 after passing through upper and lower seal jaws;

FIG. 6 is a planar view of a film roll section of a package of FIG. 4;

FIG. 7 is a side view of an assembly process to form and package a product using an exemplary re-sealable flexible film packaging; and

FIG. 8 is a cross-sectional view of a fin seal of an assembly process taken along section line A-A of FIG. 7.

FIG. 9 is a perspective view of an exemplary seal jaw to form one embodiment of a radial peal tab and end seal.

### DETAILED DESCRIPTION OF PREFERRED EMBODIMENTS

Provided herein is a flexible flow-wrap package, which has a sufficiently strong seal to retain freshness for extended periods of time, and yet “consumer friendly” in that it has a readily-grippable seal region so that it can be easily and evenly peeled and resealed, while maintaining package integrity (i.e., the film is not torn upon opening). The present invention provides peel tabs formed in the film in an un-sealed area above a package end seal allowing a user to grasp and peel open the package. The opening created at the end of the flow wrap package allows a user to remove the desired amount of product. The package provides enough film for the user to reclose the package, such as by twisting. Optional closure features can include use of wire ties, pressure sensitive labels, and interior pressure sensitive press closure layer.

Typical film package end seals do not allow a user to open the package at the end seal itself. The body of the package film is usually grasped then pulled to open the package. The peel tab allows opening the package without the need to grasp the body of the package.

The peel tabs of the present design, along with optional reseal features, can be used on both horizontal and vertical formed packages. Although the present embodiments are described for food product applications, the present applications can equally be applied to a non-food, medical, pharmaceutical, industrial package applications and the like.

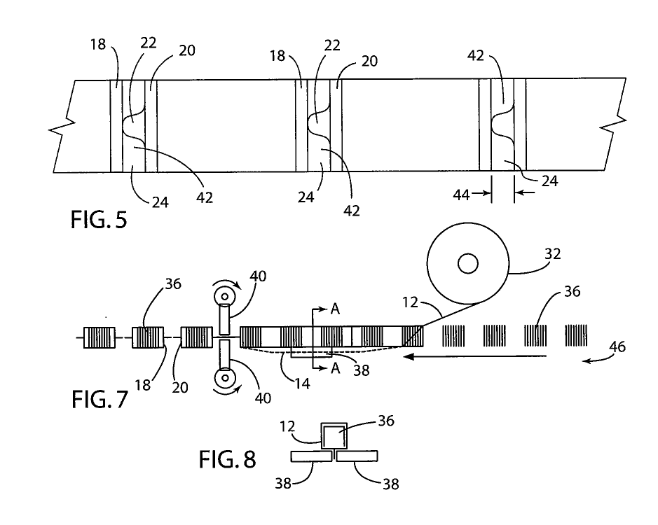

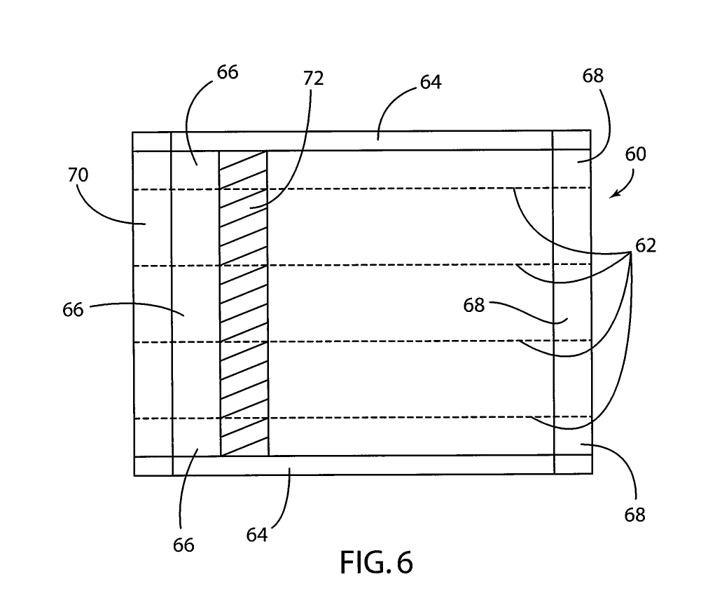

Thus, the embodiments described herein illustrate the present flexible flow-wrap and generally include packaging designed for multiple servings, formed from one piece of flexible material formed to have a fin or lap seal and two end seals, which can have hermetic seals formed by cold or heat seal processes. The design allows for easy manual opening using peel tabs, thus the seal adjacent the peel tabs is a peelable seal. The peel tabs can be formed on a film roll and cut between sequential packages (e.g., a leading seal on first package has profile matching trailing seal on second package). The peel tabs can be oriented to be on the same side as the fin or lap seal. Preferably, the package is re-closable using twistable film, wire ties, adhesive labels, an internal band of pressure sensitive adhesive and the like. In embodiments where all the seals are peelable, the sealed package can optionally be opened into one piece blank without destroying the integrity of the package material (see FIG. 6).

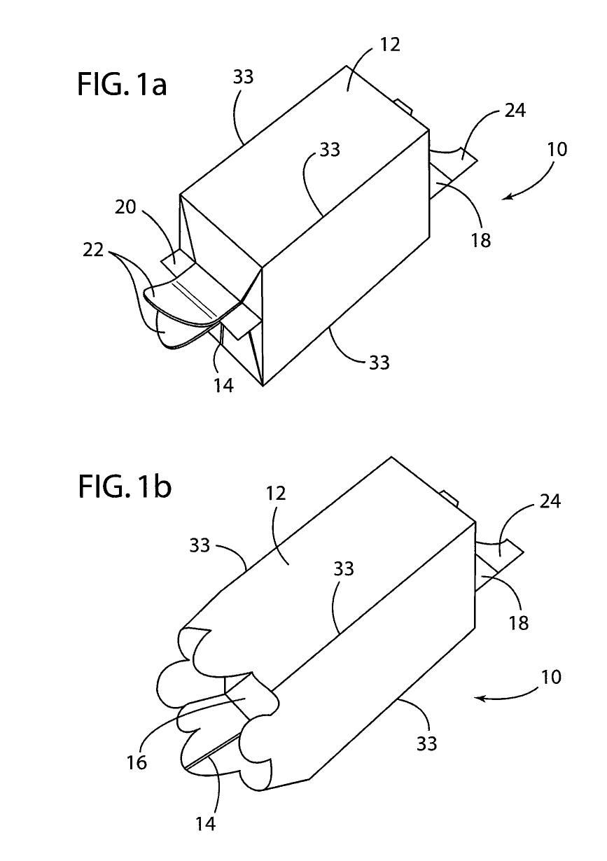

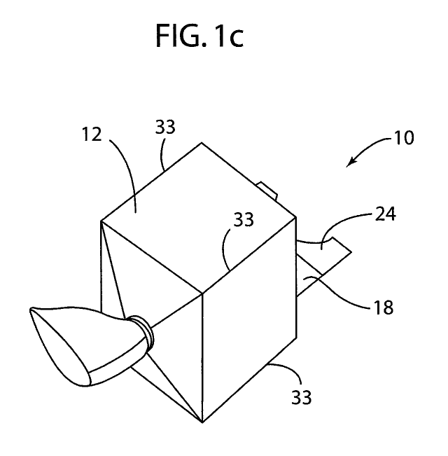

Turning now to the figures, there are illustrated preferred embodiments of the present flow wrap package design generally indicated at 10, and processes for making same. FIG. 1 shows package 10 formed from a film 12. The film can be a flexible sheet material rolled or formed as a blank and made of laminate or co-extruded film structures, with cast or blown film layers, and the like. Examples can include polypropylene and polyethylene. Generally the film can be between about 0.0127 mm and 0.0254 mm in thickness and preferably about 0.0508 mm in thickness.

The film can also have additional layers to form a laminate. A sealant layer 16 can be added to facilitate the formation of seals to enclose product during packaging. As such, the sealant layer is oriented to the interior surface of the package. The sealant layer can be a variety of polymer sealants such as a heat activated polymer sealant layer like ethylene vinyl acetate (EVA), ionomer plastic (such as one sold under the trade name SURLYN by DuPont), matallicine, orgaonclay, and the like. Cold sealant and pressure sealants are also possible. It is noted that food grade sealants would be used when food products are anticipated.

Stiffeners can also be added to the film (not shown), such as a polyamide polymer (e.g., nylon). The stiffeners can be added as a component of the extruded film or as a separate layer. The stiffeners can add stiffness to the film and aid to hold a twist of the film, thus aiding to reclose an opened package. Nylon can be added as a laminate layer held to the film structure by an adhesive, with film attached on each side of the nylon (i.e., tie layer). For illustrative purposes, the nylon layer can be about 8 percent of the film thickness or 0.00427 mm. FIG. 1c shows a twisted outside surface to secure package 10 closure.

A package 10 sleeve can be formed by joining the sealant layers of opposite sides of the film to form a fin seal 14 (described below). End seals can be trailing/end seal 18 and leading/peelable seal 20 can also be provided. A pair of peel tabs 22 can be formed on a leading edge of package 10 beyond peelable seal 20. As illustrated, peel tabs 22 are radial tabs. The trailing package edge 22 shows a concave radial corresponding to the shape of the leading edge radial when the flow wrap is formed from blanks cut out of a roll of film. Multiple peel tab shapes are possible.

It is noted that at least seal 20 is a peelable seal. Where EVA, an ionomer, or the like, are used for a sealant layer, the peelable end seal can be formed by heating the seal area between about 85 and 190 degrees Celsius. The peelability of the seal is dependent on the range of heat used for the seal, line speed, and film thickness. Generally, the higher the temperature, the lower the peelability. Optionally, the sealability of the seal can be adjusted through the use of patterns or knurls.

Optional reclosure means can be added to reseal package 10. In additional to nylon film reinforcement described above to retain film twist and excess film after product has been removed, wire ties, internal layers of pressure sensitive adhesive, or external pressure sensitive labels can be added.

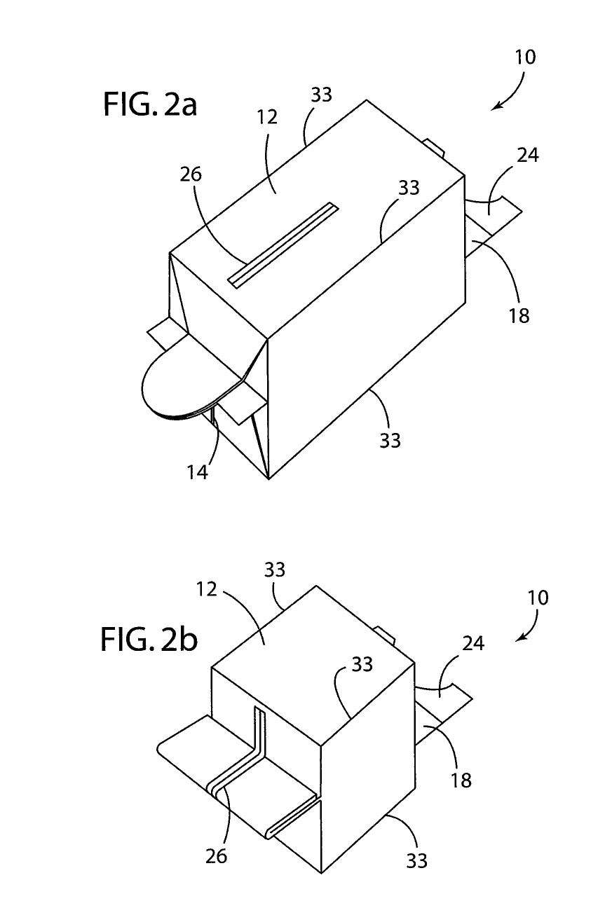

FIG. 2 shows a wire affixed to package 10. FIG. 2b shows a package 10 having reduced product, thus adding excess film to form a closure. Wire tie 26 can be folded over a folded leading edge of package 10.

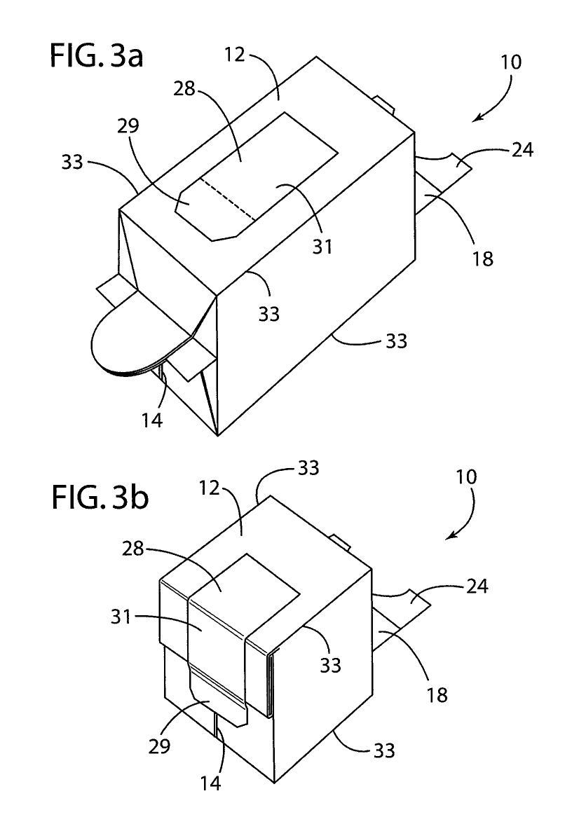

FIG. 3 illustrates shows an optional pressure sensitive label 28, which can allow a user to fold over excess film and position the label over the folded film to keep it closed. As shown, label 28 has a peelable adhesive portion 31 and a non-adhesive region 29 to serve as a tab.

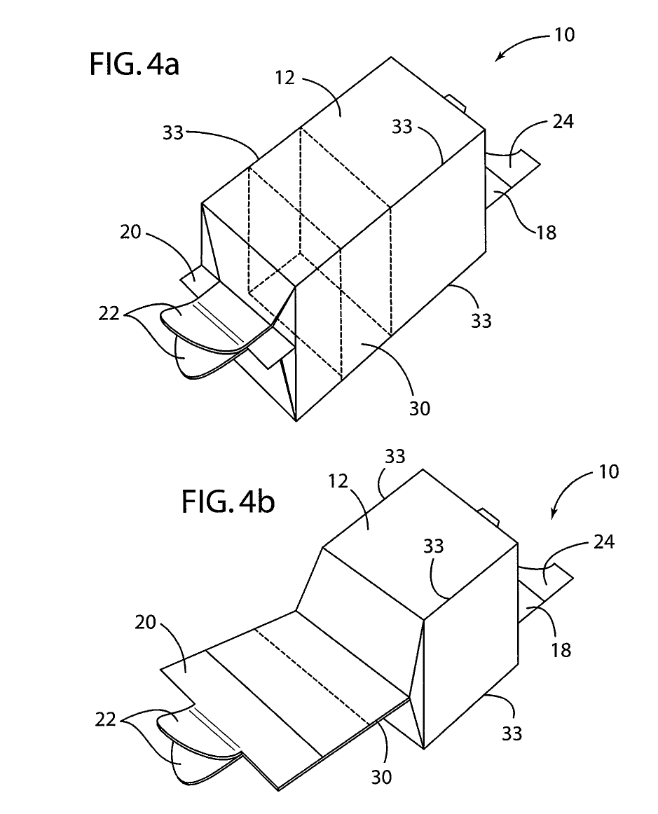

FIG. 4 shows placement of a pressure sensitive internal adhesive band 30. It is noted that internal adhesive 30 can be applied in a great variety of widths up to and including 100 percent coverage of the package's internal surface. Internal adhesive band 30 can allow a user to reseal package 10 by pressing package film together oriented with the open end of the package. Internal adhesive band is preferably neutral or non-reactive to the product.

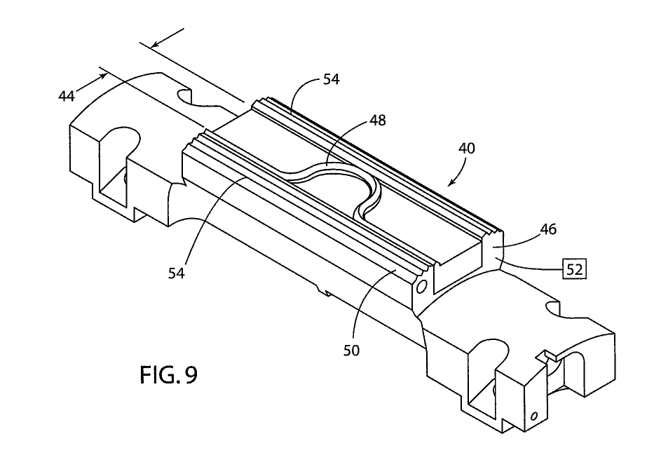

FIG. 6 a blank pattern that can be used to illustrate fold and seal lines for one package 10 using an internal band of adhesive. As shown, blank 60 has four fold lines 62 to show the corners of a package (shown as corners 33 in the embodiments) that could be used to package, for example, a square cracker. Fin seals can be formed as areas 64 are joined and sealed by heated wheels 38 (see FIGS. 7 and 8). The peelable seal can be formed in peelable seal area 66, the end seal can be formed in area 68, the unsealed area can be formed in area 70, and the internal adhesive can be applied in at least area 72. As noted previously though, the internal adhesive can be applied up to 100 percent of the interior surface.

One exemplary method of making one package embodiment is generally shown at 46 in FIG. 7. As shown, film 12 is fed from a film roll 32. Fin seal 14 can be formed as film 12 comes off a film roll 32 forming a box 34 around a product 36 (see also cross sectional view on FIG. 8). The sealant layers are pressed together heated wheels, which activates the heat sealant layer on the interior layer. Where EVA, and the like are used for a sealant layer, the heated wheels can be heated to between about 85 and 205 degrees Celsius. Again line speed and film thickness are also a factor in the seal formation and its peelability. As shown in FIGS. 7 and 8, fin seal 14 is oriented to the bottom of package 10. It is noted though that fin seal 14 can be oriented on any side of package 10.

As shown in the illustration of FIG. 7, once the film has enveloped product 36, end seals 18 and 20 can be formed by adjacent upper and lower seal jaws 40, which not only heat seal the ends of the package, but also cuts the peelable tabs in the unsealed area 42 between end seals 18 and 20. The knife can fully separate individual packages or alternately partially cut or perforate the cut between the packages to hold them together. For illustrative purposes only, unsealed area 42 can be about 6-12 mms in width between peelable seal 20 and end seal 18, as shown at dimension 44 (see FIG. 5). It is preferred that the unsealed area width 44 is wider than sealed areas 18 and 20.

Fin seal 14 and end seals 18 and 20 can optionally be formed from patterns imprinted on heated wheels 38 or seal jaws 40, which emboss the film as it is pulled through the manufacturing process.

An embodiment of a seal jaw 40 is shown in FIG. 9. As shown, the pair of seal jaws 40 rotate with film 12 moving through the production line where they meet to form end seal 18 by an end sealer 46. Next, the film is cut with a peel tab cutter die 48, followed by the forming of peelable seal 18 by peelable end sealer. The unsealed area width dimension 44 is defined by the distance between end seal 46 and peelable end sealer 50. Peel tab design, such as a radial peel tab 22 as shown in FIG. 1, are defined by the cutting die 48. In embodiments using activated heat seals, end seal 46 and peelable end sealer 50 can be heated by heater element 52. As shown, the heater heats end seal 46 and peelable end sealer 50 equally, though separate heating elements are possible where different levels of peelability are desired between end seal 18 and peelable end seal 20. End seal 46 and peelable end sealer 50, as shown in FIG. 9 also have a crimping pattern 54.

While preferred embodiments have been described in detail, variations and modifications can be effected within the scope of the invention.

I claim:

1. A resealable flexible film package, comprising:
a flexible sheet material having a sealant layer on a first surface;
the flexible sheet longitudinally sealed generally along adjacent sides to form a sleeve, the first surface forming an interior of the sleeve and adjacent surfaces of the longitudinal seal;
a first sleeve end having a peelable seal;
a second sleeve end having a second seal; and
the first sleeve end further having a pair of exterior opposing peel tabs in an unsealed area adjacent to the peelable seal.

2. The package of claim 1, wherein the flexible sheet material is selected from a list consisting of polypropylene and polyethylene.

3. The package of claim 1, wherein the sealant layer is selected from the list consisting of ethylene vinyl acetate (EVA), ionomer plastic, matallicine and orgaonclay.

4. The package of claim 1, wherein the flexible sheet material is a twist retaining film.

5. The package of claim 4, wherein the twist retaining film is formed by adding nylon to the film.

6. The package of claim 1, further comprising a wire tie affixed to the sleeve proximate to the peelable seal, whereby reclosure of an opened package can be achieved.

7. The package of claim 1, further comprising an adhesive label affixed to the sleeve proximate to the peelable seal, whereby reclosure of an opened package can be achieved.

8. The package of claim 1, further comprising a band of pressure sensitive adhesive on the first surface of the sleeve proximate to the peelable seal, whereby reclosure of an opened package can be achieved.

9. The package of claim 3, wherein the sealant layer is EVA and the peelable seal is formed by heat sealing the film in the range of between about 85 and 190 degrees Celsius.

10. A method to manufacture a resealable flexible film package, the method comprising the steps of:
feeding film from a film roll to envelop a product;
forming a fin seal by joining opposite edges of the film;
forming a first end seal;
cutting a pair of peel tabs in an exterior unsealed area; and
forming a peelable endseal.

11. The method of claim 10, wherein the step of feeding the film and forming the fin seal uses heated wheels and the film has a heat activated sealant layer.

12. The method of claim 11, wherein the heated wheels are heated to between about 85 and 205 degrees Celsius.

13. The method of claim 10, wherein the steps of forming a first end seal, cutting a pair of peel tabs in an unsealed area, and forming a peelable endseal use a pair of rotating seal jaws.

14. The method of claim 10, wherein the step of forming a first end seal and a peelable end seal further comprises the step of forming a crimped surface.

15. The method of claim 13, wherein the film has a heat activated film layer and the step of forming the peelable end seal comprises the step of heating the rotating seal jaws to between about 85 and 190 degrees Celsius.
